(19) United States
(12) Patent Application Publication
(10) Pub. No.: US 2022/0381435 A1
(43) Pub. Date: Dec. 1, 2022

(54) Portable Food Warmer and Cooker

(71) Applicants: Benjamin Maier, Florence, MT (US); Jessie Lyons, Florence, MT (US)

(72) Inventors: Benjamin Maier, Florence, MT (US); Jessie Lyons, Florence, MT (US)

(21) Appl. No.: 17/884,677

(22) Filed: Aug. 10, 2022

Related U.S. Application Data
(63) Continuation-in-part of application No. 16/534,623, filed on Aug. 7, 2019, now Pat. No. 11,426,026.
(60) Provisional application No. 62/715,441, filed on Aug. 7, 2018.

(51) Int. Cl. F24C 1/16; F24C 9/00; F24C 15/02; F02G 5/00

(52) U.S. Cl. CPC F24C 1/16; F24C 9/00; F24C 15/022; F02G 5/00; F24C 15/34

(57) ABSTRACT

A portable food warmer and cooker includes a housing having a base, a plurality of insulated sidewalls, and a latching lid. A food tray is removably securable within the interior volume of the housing. A heating coil is disposed within the interior volume of the housing such that it surrounds the food tray. The heating coil includes an inlet connector and an outlet connector, each of which extend exteriorly through one of the sidewalls of the housing. A pair of heater hoses connect the heating coil inlet and outlet to corresponding inlet and outlet connectors of a coolant system of a motor. The liquid coolant flows through the heater hoses and the heating coil, which transfers heat to the interior volume of the food tray. The device reaches high temperatures such that it can be utilized to cook raw foods utilizing the motor coolant liquid as a heat source.

### CROSS REFERENCE TO RELATED APPLICATIONS

This application is a continuation-in-part of U.S. Nonprovisional application Ser. No. 16/534,623 filed on Aug. 7, 2019, which claims the benefit of U.S. Provisional Application No. 62/715,441 filed on Aug. 7, 2018. The above identified patent applications are herein incorporated by reference in their entirety to provide continuity of disclosure.

### BACKGROUND OF THE INVENTION

The present invention relates to a food warming and cooking device. More particularly, the present invention provides a food warming and cooking device that utilizes heat transfer from the coolant liquid of a motor to warm and cook food. The device can be utilized with all-terrain vehicles, boats, cars, trucks, tractors and any other machine that utilizes an engine having a fluid coolant system.

The use of ATV's or UTV's to get people into remote places is becoming increasingly common. These trips can take a few hours or longer to get where a rider intends to go. On these trips the amenities of home like a stove top are nowhere to be found. This means that a person will have to stop their journey and light a fire or set up a stove to enjoy a hot meal. Fires can be restricted during the dry months of the year, and stoves can be expensive. This means that on such treks a person may be limited to cold foods for the journey.

It can be beneficial to utilize the waste heat of a motor in useful ways. For example, some devices in the known art exist that utilize the waste heat of a motor to warm the interior of a container, potentially for keeping food or other items warm. However, the devices in the known art have several drawbacks. For example, these devices are typically unable to attain interior temperatures that are high enough to fully cook raw foods and kill unwanted pathogens. This can lead to food borne illnesses being present, and does not give users the ability to cook completely raw foods with the device. Further, these devices lack universal mounting brackets which allow the device to be mounted to different types of vehicles.

In light of the devices disclosed in the known art, it is submitted that the present invention substantially diverges in functional and design elements from the known art and consequently it is clear that there is a need in the art for an improvement to portable food cookers and warmers, particularly with regard to the need for a device that can utilize waste heat from motor coolant fluid in order to fully cook raw foods. The present invention substantially diverges in design elements from the known art while at the same time solves a problem many people face when heating or cooking food far from home. In this regard, the present invention substantially fulfills these needs.

### SUMMARY OF THE INVENTION

The present invention provides a food warming and cooking device wherein the same can be utilized for providing convenience for the user when heating or cooking food far from home. The present system comprises a housing having a base, a plurality of insulated sidewalls, and a latching lid. A food tray is removably securable within the interior volume of the housing. A heating coil is disposed within the interior volume of the housing such that it surrounds the food tray. The heating coil includes an inlet connector and an outlet connector, each of which extend exteriorly through one of the sidewalls of the housing. A pair of heater hoses connect the heating coil inlet and outlet to corresponding inlet and outlet connectors of a coolant system of a motor. The liquid coolant flows through the heater hoses and the heating coil, which transfers heat to the interior volume of the food tray. The device reaches high temperatures such that it can be utilized to cook raw foods utilizing the motor coolant liquid as a heat source.

One object of the present invention is to provide a portable food warming and cooking device that is capable of maintaining temperatures of above one hundred and eighty degrees Fahrenheit for continuous extended periods of time in order to fully cook raw foods that are stored within the device.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the portable food warmer and cooker with a cutaway showing a portion of the interior.

FIG. 2 shows a top down view of an embodiment of the portable food warmer and cooker with the lid removed.

FIG. 3 shows a perspective view of an embodiment of the portable food warmer and cooker secured to a vehicle body.

FIG. 4 shows a diagram detailing the components of an embodiment of the portable food warmer and cooker.

### DETAILED DESCRIPTION OF THE INVENTION

Reference is made herein to the attached drawings. Like reference numerals are used throughout the drawings to depict like or similar elements of the portable food warmer and cooker. For the purposes of presenting a brief and clear description of the present invention, a preferred embodiment will be discussed as used for heating up or fully cooking raw foods in remote locations using a vehicle motor's coolant fluid as a heat source. The figures are intended for representative purposes only and should not be considered to be limiting in any respect.

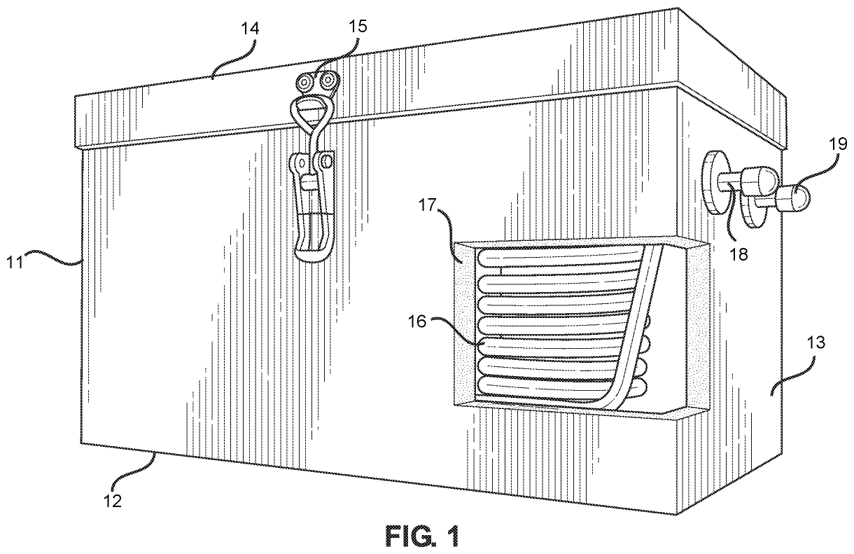

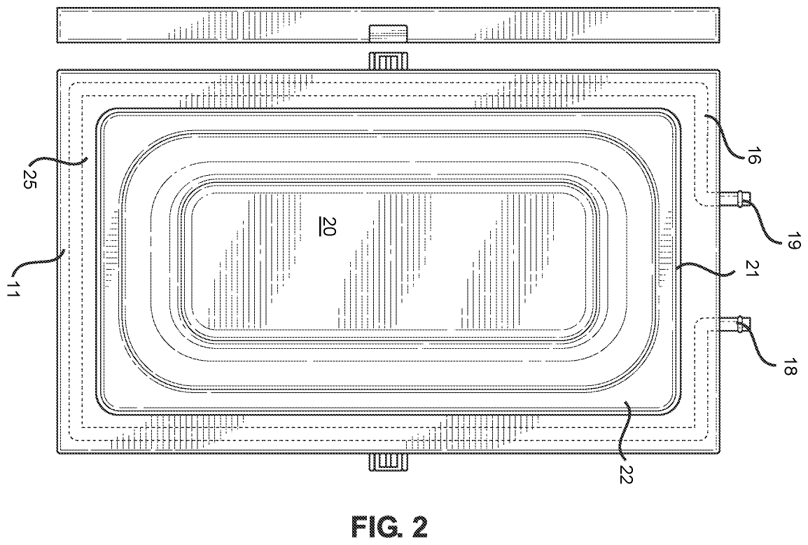

Referring now to FIG. 1, there is shown a perspective view of an embodiment of the portable food warmer and cooker with a cutaway showing a portion of the interior. The portable food warmer and cooker includes a housing 11 comprising a base 12, a plurality of sidewalls 13 extending upwardly from the base 12, and a lid 14 that is movable between an open configuration and a closed configuration. The housing 11 may be made with heat resistant materials, insulating materials, metal materials, or any other suitable material. In the shown embodiment, the housing includes a rectangle shape, but other embodiments may include different shapes, sizes, and the like. In one embodiment, the lid 14 can be affixed to one of the sidewalls 13 via one or more hinges. In another embodiment, the lid 14 can be completely separable from the housing 11. In the shown embodiment, the lid includes a latch 15 that allows the lid to be locked in the closed position. In other embodiments, such as that shown in FIG. 2, there may be multiple latches 15 on opposing sides of the housing 11 for further securement of the lid 14.

A heating coil 16 is disposed within the interior volume of the housing 11. The heating coil 16 is a coiled hollow tube that is configured for fluid flow. Specifically, the heating coil 16 receives liquid coolant material from a liquid cooled motor, such as an internal combustion engine, as one example. The heating coil 16 connects to an inlet connector 18 at one end and to an outlet connector 19 at another end. The inlet and outlet connectors 18, 19 are configured to connect to heater hoses that in turn connect to the motor's coolant system, such that coolant fluid can circulate through the heating coil. The inlet and outlet connectors 18, 19 extend outwardly from one sidewall of the plurality of sidewalls 13. In the shown embodiment, there are stoppers that are removably securable over the inlet and outlet connectors of the heating coil 16, which protect the connectors 18, 19 when the device is not in use or in transport.

The heating coil 16 may be made from a highly conductive and/or convective material to improve heat transfer from the fluid within the heating coil 16 to the interior volume of the housing 11 in order to heat and cook food stored therein. In order to retain heat, the housing includes a layer of insulating material 17 disposed within a hollow interior portion of the sidewalls 13 of the housing 11. The insulating material 17 may be an insulating foam or any other suitable material. The heating coil 16 is also wound within the interior volume in such a way as to maximize the surface area for improved radiant heat transfer. Additionally, the arrangement of the heating coil 16 and the insulating properties of the housing 11 allow for the interior volume of the housing and an interior portion of the food tray (visible in FIG. 2) to maintain temperatures greater than one hundred eighty degrees Fahrenheit when the portable food warmer and cooker is in operation, and upwards of two hundred degrees Fahrenheit. These temperatures are high enough to ensure any raw foods are fully cooked when placed within the device for a sufficient amount of time.

Referring now to FIG. 2, there is shown a top down view of an embodiment of the portable food warmer and cooker with the lid removed. A food tray 21 is removably secured within the interior volume of the housing 11. The food tray 21 includes a base 20 and sidewalls that define an interior volume that supports food for heating and cooking. The food tray 21 may be removable for cleaning or replacement if needed. In the shown embodiment, the food tray 21 includes a perimeter lip 22 that rests on an upper perimeter edge of the housing 11 when the food tray 21 is secured within the interior volume of the housing 11, which helps to support and maintain the food tray 21 in a secure position within the housing 11. The heating coil 16 is arranged such that it surrounds the sidewalls of the food tray 21 when the food tray is secured within the interior volume of the housing 11. This allows for efficient and effective heat transfer. The inlet and outlet connectors 18, 19 are configured to removably connect to the heater hoses, shown in the following figure. The inlet and outlet connectors 18, 19 may include quick connect fittings, threaded connectors, hose clamps, or any other suitable type of hose connection. Further, the shown embodiment includes a pair of latches 15 in order to secure the lid 14 in place while a vehicle travels over rough terrain, improving the durability of the present invention.

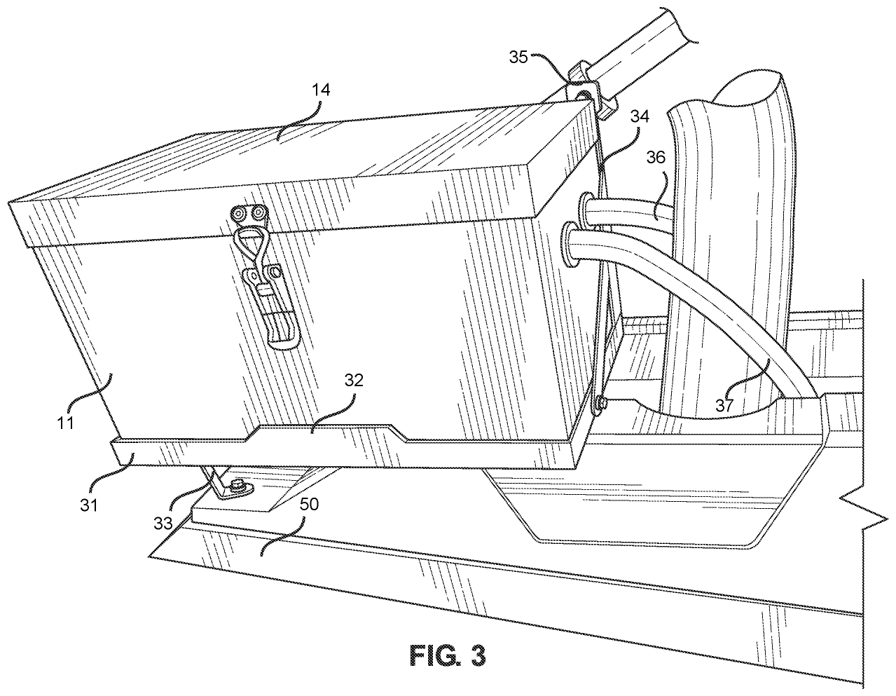

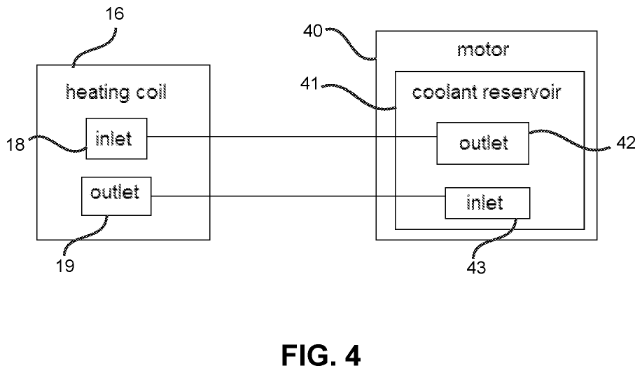

Referring now to FIG. 3, there is shown a perspective view of an embodiment of the portable food warmer and cooker secured to a vehicle body. A first heater hose 36 includes a first end connected to the inlet connector of the heating coil and a second end connected to an outlet connector of a coolant system of a motor, as detailed in the diagram of FIG. 4. A second heater hose 37 includes a first end connected to the outlet connector of the heating coil and a second end connected to an inlet connector of a coolant system of a motor. The heating coil is in fluid communication with a coolant reservoir of the coolant system of the motor via the first and second heater hoses, such that liquid flows from the coolant system, through the heating coil, and back into the coolant system.

In the shown embodiment, the housing 11 is secured to a body of an all-terrain vehicle. A mounting bracket 13 removably supports a lower end of the housing. A perimeter wall 32 extending upwardly from perimeter edges of the base of the mounting bracket 13 retains the housing 11 within the mounting bracket 13. In the shown embodiment, the mounting bracket 31 further includes a securement arm 34 having a fastener configured to removably secure the housing 11 to the mounting bracket 13. The mounting bracket 31 also includes one or more mounting arms 33 having one or more fasteners, wherein the one or more mounting arms 33 are configured to removably secure the mounting bracket 31 to a mounting surface, such as the body 50 of the vehicle, as one example. There may also be additional clamps 35 for further securing the housing 11 to different mounting points.

Referring now to FIG. 4, there is shown a diagram detailing the components of an embodiment of the portable food warmer and cooker. The heating coil 16 is in fluid communication with a coolant reservoir 41 of the coolant system of the motor via the first and second heater hoses, which connect the heating coil inlet 18 to a coolant reservoir outlet 42, and the coolant reservoir 43 inlet to the heating coil outlet 19, establishing a fluid loop. In operation, coolant liquid flows from the coolant reservoir 41, through the heating coil 16, and back into the coolant system. The flow of the heated coolant fluid into the heating coil 16 is sufficient to raise the interior temperature of the device housing to above one hundred eighty degrees Fahrenheit, which will fully cook any raw foods within the device.

The specific structure of the inlet and outlet 42, 43 for the coolant reservoir 41 can vary. For example, in one embodiment the inlet and outlet may be part of a T-valve or other similar type of splitter that establishes a closed loop for the fluid coolant flow. When the heater hoses are connected to the coolant system via a T-valve connection the connection will allow the coolant to flow through the engine properly and the portable warming and cooking device. Other types of connections may be utilized in other embodiments. Further, in some embodiments, the user can select the flow rate of coolant to the portable food warmer and cooker.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A portable food warmer and cooker, comprising:
a housing comprising a base, a plurality of sidewalls extending upwardly therefrom, and a lid that is movable between an open configuration and a closed configuration;
a food tray removably secured within an interior volume of the housing;
a heating coil disposed within the interior volume of the housing;
an inlet connector which is connected to a first end of the heating coil and an outlet connector which is connected to a second end of the heating coil, the inlet and outlet connectors extending outwardly from one sidewall of the plurality of sidewalls;
a first heater hose comprising a first end connected to the inlet connector of the heating coil and a second end connected to an outlet connector of a coolant system of a motor;
a second heater hose comprising a first end connected to the outlet connector of the heating coil and a second end connected to an inlet connector of a coolant system of a motor;
wherein the heating coil is in fluid communication with a coolant reservoir of the coolant system of the motor via the first and second heater hoses, such that liquid flows from the coolant system, through the heating coil, and back into the coolant system.

2) The portable food warmer and cooker of claim 1, further comprising a latch on the lid such that the lid can be locked in the closed position.

3) The portable food warmer and cooker of claim 1, wherein the latch comprises a pair of latches on opposing sides of the housing.

4) The portable food warmer and cooker of claim 1, further comprising a layer of insulating material disposed within a hollow interior portion of the plurality of sidewalls of the housing.

5) The portable food warmer and cooker of claim 1, wherein the food tray includes a perimeter lip that rests on an upper perimeter edge of the housing when the food tray is secured within the interior volume of the housing.

6) The portable food warmer and cooker of claim 1, wherein the inlet connector and outlet connector of the of the heating coil comprise quick connect fittings.

7) The portable food warmer and cooker of claim 1, wherein the heating coil is arranged such that the heating coil surrounds the plurality of sidewalls of the food tray when the food tray is secured within the interior volume of the housing.

8) The portable food warmer and cooker of claim 1, wherein the interior volume of the housing and an interior portion of the food tray are configured to maintain temperatures greater than one hundred eighty degrees Fahrenheit when the portable food warmer and cooker is in operation.

9) The portable food warmer and cooker of claim 1, further comprising stoppers that are removably securable over the inlet and outlet connectors of the heating coil.

10) The portable food warmer and cooker of claim 1, further comprising a mounting bracket that removably supports a lower end of the housing.

11) The portable food warmer and cooker of claim 10, wherein the mounting bracket further comprises a perimeter wall extending upwardly from perimeter edges of the base, wherein the perimeter wall retains the housing.

12) The portable food warmer and cooker of claim 10, wherein the mounting bracket further comprises one or more securement arms having one or more fasteners, wherein the one or more securement arms are configured to removably secure the housing to the mounting bracket.

13) The portable food warmer and cooker of claim 10, wherein the mounting bracket further comprises one or more mounting arms having one or more fasteners, wherein the one or more mounting arms are configured to removably secure the mounting bracket to a mounting surface.

14) The portable food warmer and cooker of claim 13, wherein the mounting surface comprises a portion of a vehicle.
